(19) United States
(12) Patent Application Publication
(10) Pub. No.: US 2016/0065329 A1
(43) Pub. Date: Mar. 3, 2016

(54) SINGLE CARRIER COMMUNICATIONS HARNESSING NONLINEARITY

(71) Applicant: MagnaCom Ltd., Petach Tikva (IL)

(72) Inventors: Daniel Stopler, Holon (IL); Roy Oren, Magshimim (IL); Ilan Reuven, Ganey Tikva (IL); Amir Eliaz, Moshav Ben Shemen (IL); Shimon Benjo, Petach Tikva (IL)

(21) Appl. No.: 14/832,094

(22) Filed: Aug. 21, 2015

Related U.S. Application Data
(60) Provisional application No. 62/048,329, filed on Sep. 10, 2014.
(60) Provisional application No. 62/042,458, filed on Aug. 27, 2014.

(51) Int. Cl. H04L 1/00; H04B 1/7097; H04B 1/16

(52) U.S. Cl. CPC H04L 1/0047; H04B 1/16; H04B 1/7097

(57) ABSTRACT

A single-carrier receiver comprises a (FEC) decoder and a nonlinearity compensation circuit. The nonlinearity compensation circuit is operable to generate estimates of constellation points transmitted on a received signal based on soft decisions from the FEC decoder and based on a model of nonlinear distortion introduced by a transmitter from which the received signal was received. The generation of the estimates may be based on a measure of distance between a function of the received signal and a synthesized version of the received signal. The generation of the estimates may comprise iterative processing of symbols of the received signal, and the iterative processing may comprise a plurality of outer iterations and a plurality of inner iterations.

### PRIORITY CLAIM

This patent application makes reference to, claims priority to, and claims benefit from U.S. Provisional Application Ser. No. 62/048,329, which was filed on Sep. 10, 2014; and U.S. Provisional Application Ser. No. 62/042,458, which was filed on Aug. 27, 2014.

Each of the above stated applications is hereby incorporated herein by reference in its entirety.

### BACKGROUND

Limitations and disadvantages of conventional and traditional approaches to electronic communications will become apparent to one of skill in the art, through comparison of such systems with some aspects of the present invention as set forth in the remainder of the present application with reference to the drawings.

### SUMMARY

A system and/or method is provided for single carrier communications harnessing nonlinearity, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF THE FIGURES

FIG. 1 depicts a transmitter in accordance with an example implementation of this disclosure.

FIG. 2 depicts AM-to-AM and AM-to-PM response of a typical power amplifier with and without intervention by the digital predistortion circuit of the transmitter.

FIG. 3 depicts a receiver in accordance with an example implementation of this disclosure.

FIG. 4 depicts a generalized model of nonlinearity.

FIG. 5 depicts circuitry configured for minimizing a cost function using gradient descent.

FIG. 6 is a graph depicting performance of a conventional 1024QAM OFDM system.

FIG. 7 depicts an example wireless communication system in accordance with an example implantation of this disclosure.

FIG. 8 is a flowchart describing example operations of the system of FIG.

FIG. 9 depicts an example single carrier transmitter in accordance with aspects of this disclosure.

FIG. 10 depicts an example single carrier receiver in accordance with aspects of this disclosure

### DETAILED DESCRIPTION

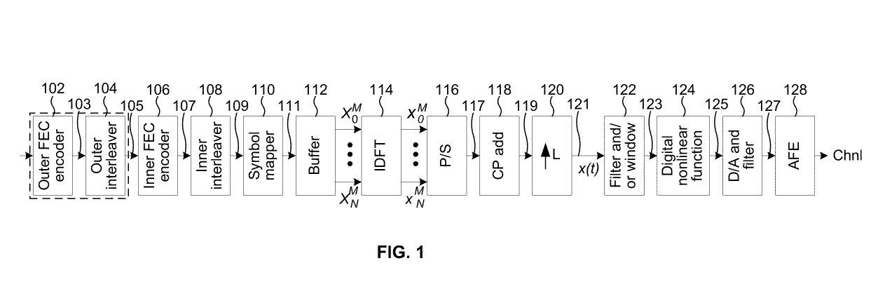

A transmitter in accordance with an example implementation of this disclosure is depicted in FIG. 1.

‘M’ in FIG. 1 is the OFDM symbol index and ‘N’ is the size of the IDFT 114.

In an example implementation, the Inner FEC encoder 106 codeword size is aligned to IDFT 114 size (i.e. IFT 114 accommodates an integer number of FEC code-words, or FEC code-word size accommodates integer number of FFT's). In an example implementation the inner FEC encoder 106 and Mapper 110 may be merged thereby creating a Euclidean code.

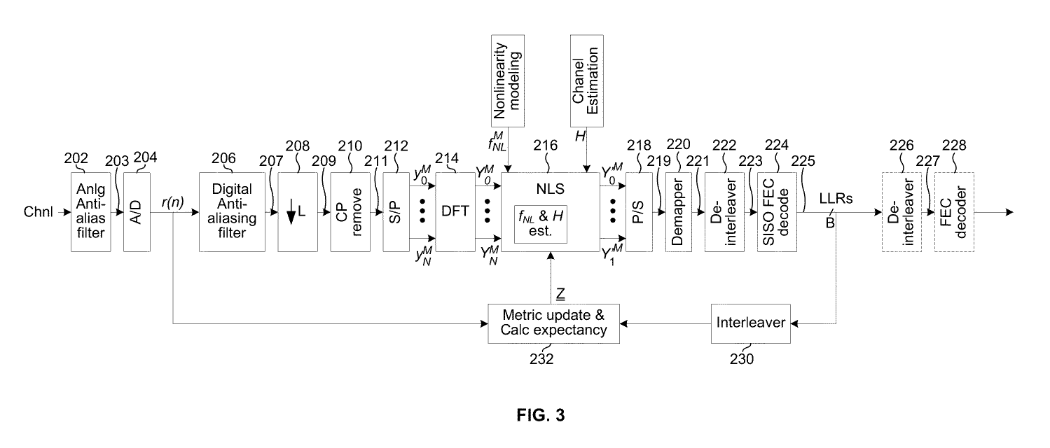

As indicated by the dashed lines, the outer FEC 102 may not be used in some implementations. In this regard, in an example implementation in which the codeword size of the inner FEC encoder 106, which is aligned to the OFDM symbol, is too short to get good coding gain, then the outer FEC encoder 102 may accordingly be used. In such an implementation, the rate of the code may be split between the outer FEC encoder 102 and the inner FEC encoder 106. For example, to get a total code rate of 0.9 the rate of the inner FEC encoder 106 (Rᵢₙ) and the rate of the outer FEC encoder 102 (Rₒᵤₜ) may be set such that Rᵢₙ*Rₒᵤₜ=0.9. In such an implementation, the inner FEC encoder 106 and corresponding SISO FEC decoder 224 (FIG. 3) may be specifically designed for handling nonlinearity.

As indicated by the dashed lines, the outer interleaver 104 may not be used in all implementations. In this regard, the outer interleaver 104 may be used in implementations where channel fading is such that it is desired to have a big enough interleaver which spans over several OFDM symbols.

In an example implementation, the FEC 106 may not be aligned IDFT 114. The receiver may be configured to be capable of demodulating non-aligned FEC blocks.

In an example implementation where the transmitter has information on the selectivity of the fading channel from transmitter to receiver, the Symbol Mapper 110 may be used to zero out frequency bins that undergo extreme attenuation. In another example the Symbol Mapper 110 may be used to set these frequency bins to values known to the receiver—i.e. pilots. This is beneficial, for example, in the case of a highly distorted power amplifier (PA) since the extremely attenuated bins contribute very little mutual information to the receiver, while also non-linearly mixing with other bins and increasing their distortion. In particular, the receiver typically tracks the OFDM channel continuously. The receiver may periodically determine those frequency bins being so highly attenuated that they inflict more distortion than contributing useful signal. The receiver then periodically sends a list indicating these bins to the transmitter. In which case the Symbol Mapper 110 may zero out the transmission signal of those bins. Thus, the receiver knows the transmitted values on these bins exactly—either zeros or scrambled pilots—for the purpose of computing distortion. The receiver, for the purpose of FEC decoding, considers the bits carried by these subcarriers as punctured by zeroing out the soft decisions (e.g., log likelihood ratios LLRs) for such subcarriers. In some cases, the transmitter may determine by itself the list of bins to zero, e.g. by use of channel reciprocity, in this case a more robust packet header may be transmitted including a list of zeroed bins. In an example, the more robust packet header uses lower constellations and lower rate and thus can be demodulated without aid of the NLS circuitry 216 (e.g., it may be bypassed and/or powered down during processing of the header).

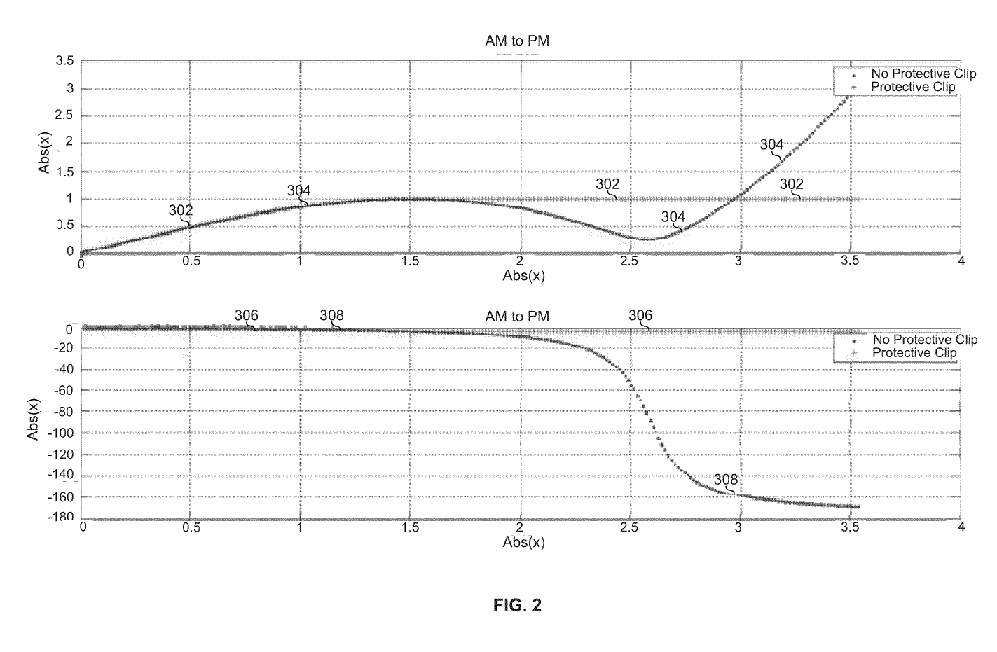

In accordance with aspects of this disclosure, the transmitter may operate in scenarios where the Power Amplifier (PA) of the analog front end 128 is deeply compressed. Without the digital nonlinear function (DNF) circuitry 124 (which introduces digital predistortion such as, for example, protective clipping), the AM to AM characteristic of the PA may not be one-to-one, as depicted by lines 304 and 302 of FIG. 2 (line 304 corresponds to without protective clipping by the DNF circuitry 124, and line 302 corresponds to with protective clipping by the DNF circuitry 124). Lines 306 and 308 of FIG. 2 similarly illustrate the impact of protective clipping by the DNF circuitry 124 on the AM to PM response. The nonlinearity of the DNF circuitry 124 may predominate the overall nonlinear characteristic of the transmitter such that the nonlinear characteristic may be substantially-known (i.e., known to be substantially equal to the nonlinear characteristics of the DNF circuitry 124), as opposed to the response of the PA which may vary somewhat unpredictably over time. Because the nonlinearity of the transmitted signal is substantially the nonlinearity of the DNF circuitry 124, the DNF circuitry 124 may be configured to have a nonlinearity that simplifies the reconstruction of the data by using the known nonlinearity. Below the clipping threshold (where a “soft clip” is implemented either by the DNF 124 or a separate digital predistortion circuit concatenated with the DNF circuit 124), the response of the DNF 124 may be nonlinear below the clipping threshold, and, in an example implementation, this nonlinearity may be different than the inverse of the power amplifier response below the clipping threshold. Thus, the response of the concatenation of the DNF circuit 124, digital predistortion circuit (optional), and power amplifier may be the clipped response above the clipping threshold and may be substantially nonlinear below the clipping threshold (with that substantial nonlinearity being dominated by the response of the DNF circuit 124).

A receiver in accordance with an example implementation of this disclosure is depicted in FIG. 3. Notation used in FIG. 3 is as follows: M is the OFDM symbol index, N is the size of the DFT 214, f_{NL} is a model of nonlinearity experienced by the received samples y, H is the estimated transfer characteristic of the channel via which the samples y were received, B is the number of bits per symbol (e.g., B=10 for 1024-QAM), and Z^{M} is a vector of metrics (e.g., \hat{X} (i.e., estimated transmitted subcarrier value which may be, for example, the expectation of X), a quantization of \hat{X} to the nearest point of the constellation that is in use, and/or minimal bit LLR for each symbol) for OFDM symbol M.

In an example implementation, f_{NL} is updated according to the rate at which characteristics of the analog front end 128 (e.g., comprising a power amplifier and, in some instances, an upconverter) change. In an example implementation, f_{NL} may be updated each OFDM symbol, or once per every few OFDM symbols. In an example implementation in which burst transmissions are used, f_{NL} may be updated at start of each burst. In an example implementation, f_{NL} may be adapted using dedicated preambles or beacon patterns that are generated once in a while (e.g., periodically, pseudo-randomly, and/or the like) by the transmitter. In an example implementation, f_{NL} may be adapted based on \hat{X} and/or other metrics calculated based on the LLRs output by FEC decoder 224, as further described below.

### Update Metric

In various example implementations, the receiver uses so called “outer” iterations, where at each iteration the output 225 of SISO (Soft-In-Soft-Out) FEC (“inner FEC”) decoder 224, and the output r(n) of ADC 204 is used to improve the received subcarriers by partially compensating for the nonlinear characteristic of the transmitter.

Three example implementations of the NLS (non-linear-solver) circuitry 216 will now be described.

### First Example Implementation of NLS Circuitry 216

Denoting by d the vector of the distortion in the time domain (i.e. the difference between samples which passed through the PA of AFE 128 and samples which would have been created had the PA of AFE 128 been linear), and denoting by e the vector of errors in the frequency domain (i.e. difference between the vector X (output of symbol mapper 110) and the vector Y′ (output of NLS circuit 216)). It is possible to estimate e, by using the SISO FEC decoder 224 and then estimating d using equation (1).

e=H·F·d (1)

where:
F is the N×NL (N is DFT size and NL is number of samples after upsampling by L) DFT matrix convolved with the digital anti-alias filter.
H is the diagonal frequency-domain channel response matrix.

In an example implementation, processing in the NLS circuitry 216 initially focuses only on the stronger elements in vector d, based on the assumption that these elements would appear at locations where the received signal was strong (since the distortion is proportional to the signal level). Metric update and expectancy calculation circuit 232 may process the signal r(n) to identify the d strongest elements. To estimate the d elements, those elements from vector e that have higher probability of being correct may be used. The probability of any particular element of vector e being correct may be determined based on corresponding soft outputs of the SISO FEC decoder 224.

Thus Equation (1) can be punctured in both time and frequency such that there are more observations than parameters. H would then become a punctured DFT matrix with size: K×length(d), where:
length(d) is the number of elements in the time domain vector d searched and K denotes the number of subcarriers used for this estimation (i.e., the number of elements of vector e whose probability of being correct is above a determined threshold).

A Least Squares method may be used to find the parameters d which best fit the model (i.e., find d for which the cost function shown in equation (2) is minimal).

∥e−H·F·d∥²+d^{H}·W·d (2)

Solving equation (2) for d results in equation (3).

\hat{d}=inv(F^{H}·H^{H}·H·F+W)·F^{H}·H^{H}·e (3)

where:
W is a diagonal weight matrix, the elements of which may be set according to the assumption that the distortion is proportional to the signal level. For example, the diagonals of W may be set to |H²|/|Y²| or |H|/|Y|.

Equation (3) is solvable as long as there are more observations than parameters (i.e. the number of elements used in e is larger than the number of elements being estimated in d).

Knowing the parts of the distortion in time domain, the NLS circuitry 216 may reflect it to frequency domain and continue iteratively. With each iteration, the number of elements of e which can be used increases, thus enabling estimation of more elements in d.

### Second Example Implementation of NLS Circuitry 216

In this example implementation, the NLS circuitry 216 may use a cost function of the form of equation (4) for estimating ΔX:

$${\sum }_{n = 0}^{{N}_{FFT} - 1} \frac{1}{{σ}_{v}^{2}} {\vert r ( n ) - h Θ {f}_{NL} ( IDFT ( \hat{X} ) + IDFT ( Δ X ) ) \vert}^{2} + {\sum }_{k = 0}^{{N}_{FFT} - 1} \frac{{\vert Δ {X}_{k} \vert}^{2}}{{σ}_{k}^{2}} , \qquad ( 4 )$$

where:
N_{FFT}—is the FFT size
f_{NL}(x)—is the overall nonlinear response experienced by signals received by the receiver. In an example implementation this may be dominated by non-linear response of the transmitter (e.g., the response of the AFE 128 and/or the response of the DNF circuitry 124) as depicted in FIG. 2 (AM to AM distortion and AM to PM distortion). It can be implemented, for example, as a mathematical computation or a Look Up Table (LUT)
r(n)—is the received time-domain signal;
\hat{X}ₖ—is the estimated transmitted subcarrier k (e.g., calculated as the expectation of X);
X is the transmitted vector of symbols (input of IDFT 114 in FIG. 1)
\hat{X}—is the vector whose elements are \hat{X}ₖ;
ΔXₖ—is an estimation of the error at sub-carrier k (i.e., element k of the vector X−\hat{X});
ΔX—is the vector whose elements are ΔXₖ;
σᵥ²—is the noise floor (in time);
h—is the channel response; and
σₖ²—is the reliability measure for \hat{X}ₖ. That is, when there is high reliability estimate for subcarrier k, then it would be reflected in the cost function as a small σₖ² in order to induce relatively high penalty to deviations from this estimate. In an example implementation, σₖ², may be set to the variance of \hat{X}ₖ. In an example implementation, σₖ², may be a function of the LLRs output by the SISO FEC decoder 224 (e.g., a function of the inverse of the min(|LLR|). In an example implementation, when σₖ², is below some determined threshold for a particular symbol, it may be set to ∞ for that symbol to indicate the symbol is bad.

The receiver uses outer iterations where, at each iteration, an estimation of ΔXₖ (for one or more values of k) that minimizes the cost function of (4) is produced by NLS circuitry 216 and re-fed to the FEC decoder 224. The cost function need not necessarily find the best solution for ΔXₖ, but need only find new value of ΔXₖ that reduces the cost, while providing information that is extrinsic to the FEC decoder 224. This refinement is iteratively used in the FEC decoder 224 to further distill \hat{X}. This iterative scheme uses the nonlinear function f_{NL} as an inner (time domain) code used with an outer (frequency domain) FEC code. The NLS circuitry 216 uses constraints, such as those shown in (4), on the time-domain signal to aid in generation of its output, and the FEC 224 similarly imposes constraints on the frequency domain representation of the same signal, as discussed below, to aid in generation of its output. Each one of the NLS circuitry 216 and the FEC decoder 224 uses a refinement of the data estimation generated by the other in order to improve its own estimate based on different, independent constraints in an iterative scheme.

In an example implementation, \hat{X} is estimated by the Metric Update block 232 by calculating \hat{X} using LLR's from the SISO FEC decoder 224 (“mapping” the LLR's).

In an example implementation the cost function (4) is minimized by use of gradient descent to find all or a subset of the subcarriers corrections ΔXₖ. In an example implementation, ΔXₖ may be estimated for all subcarriers during each iteration.

In an example implementation, only those subcarriers for which the confidence of being erroneous is high (e.g., based on LLRs output by the SISO FEC decoder 224) may be estimated during a particular iteration and other subcarriers, referred to here as “good,” (e.g. those subcarriers having a decoded LLR above a determined threshold) may be fixed based on an assumption that the output of FEC decoder 224 is correct. The ΔXₖ for good subcarriers may, for example, be fixed at a value of zero while adapting the ΔXₖ for the other subcarriers.

The values of X are limited to some constellation χ (e.g. 1024QAM). Therefore the estimated value to the same constellation (i.e. (\hat{X}ₖ+ΔXₖ)εχ). This, however, results in a very difficult discrete minimization problem. To overcome this difficulty, in one example implementation, ΔXₖ+ΔXₖ is limited to a rectangular range (|re(\hat{X}ₖ+ΔXₖ)|≦Xₘₐₓ and |im(\hat{X}ₖ+ΔXₖ)|≦Xₘₐₓ) that includes the constellation χ, this is called the hard bound approach. The down side of this approach is that gradient descent convergence is slowed down by the hard bounds. Accordingly, in an example implementation, soft bounds may be used as an additional penalty term to the cost function (e.g., values of \hat{X}ₖ+ΔXₖ outside the constellation rectangle are penalized with a penalty increasing with distance from the constellation rectangle, as shown in equation (5) below).

(|re(x)|>Xₘₐₓ)(|re(x)|−|Xₘₐₓ|)²+(|im(x)|>Xₘₐₓ)(|im(x)|−|Xₘₐₓ|)² (5)

where:
Xₘₐₓ—Is maximum constellation value (e.g. 31 for 1024 QAM)
(a>b)—evaluates to 1 if the condition is true and zero otherwise.

Referring back to FIG. 3, for this second example implementation of the NLS circuitry 216, Y′^{M} output by the NLS circuitry 216 may be equal to \hat{X}^{M}+ΔX^{M}.

### Third Example Implementation of the NLS Circuitry 216

This implementation is similar to the second example NLS implementation above, but using the frequency-domain cost function of equation (6).

$$\frac{1}{{σ}_{v}^{2}} {‖ Y - H \cdot DFT ( {f}_{NL} ( IDFT ( \hat{X} ) + IDFT ( Δ X ) ) ) ‖}^{2} + {\sum }_{k = 0}^{{N}_{FFT} - 1} \frac{{\vert Δ {X}_{k} \vert}^{2}}{{σ}_{k}^{2}} \qquad ( 6 )$$

where:
∥•∥—denotes the Frobenius norm of a vector.
Yₖ—is the DFT of r(n), at subcarrier k (i.e., Yₖ=Σₙ₌₀^{N}^{_{FFT}}⁻¹r(n)·e^{-(in·k/N}^{_{FFT}}⁾)
Y—is a vector whose elements are Yₖ
H—is a N_{FFT} by N_{FFT} matrix

In an example implementation in which phase noise is negligible, H may be a purely diagonal matrix with the DFT of the channel response being on the diagonal. In an example implementation, the matrix H may comprise off-diagonal elements to compensate for phase noise and/or any other Inter-Carrier Interference (e.g. caused by fast varying channel).

### Splitting the Problem to Two Dimensions

In an example implementation, to increase the diversity of the cost with respect to “good” decision errors we may minimize real(X) and imag(X) as separate variables. This allows performance improvement by deciding on the reliability of single dimension symbols (i.e. good/bad decisions taken separately on real part and separately on imaginary part), rather than the reliability of complex symbols (e.g., for a certain subcarrier Xₖ the real part may be considered bad and take part in minimization, while the imaginary part may be considered good and kept fixed).

Hard Metric Vs. Soft Metric

As mentioned above, the 2nd term in equations (4) and (6) indicates the reliability of Xₖ. When σₖ² is close to 0, the cost would only allow using values of ΔXₖ which are very small.

In an example implementation, the second term may be dropped from equations (4) and (6). Instead, the NLS circuitry 216 may determine which of the elements in \hat{X} are reliable, (denoted as “good” subcarriers) and which elements in \hat{X} are unreliable (“bad” subcarriers) and operate as follows: During the 1st iteration on an OFDM symbol m, the NLS circuitry 216 may assume that all subcarriers are bad subcarriers, and then search for N_{FFT} ΔXₖ elements (or 2·N_{FFT} ΔXₖ elements if working independently on real and imaginary dimensions). Then, in later iterations, the NLS circuitry 216 may get information from the Metric Update block 232 which enables the NLS circuitry 216 to lower the number of ΔXₖ elements in the search (i.e. fix the good subcarriers to constant values), and the problem boils down to finding the bad subcarriers that minimize the cost. Thus, the NLS circuitry 216 may search for N_{bad} (where N_{bad}<N_{FFT}) ΔXₖ elements corresponding to the N_{bad} bad subcarriers. In such an implementation, the hard metric cost function may be as shown in equation (7).

∥Y−H·DFT(f_{NL}(IDFT(\tilde{X})))∥²

where:

$${\tilde{X}}_{k} = \{ \begin{matrix}{\hat{X}}_{k} & when {θ}_{k} < TH \\ {\hat{X}}_{k} + Δ {X}_{k} & otherwise\end{matrix}$$

TH—is a threshold for selecting the good subcarriers. In an example implementation, the NLS circuitry 216 determines good/bad by comparing the metric θₖ to a threshold TH (e.g., if θₖ<TH then subcarrier k is considered a good subcarrier). In an example implementation the threshold TH is fixed at a determined value. In another example implementation, described below, TH may be dynamically configured.
θₖ—is a metric that is used to determine if a subcarrier is a good subcarrier or a bad subcarrier. The metric θₖ is determined by metric update block 232. In an example implementation θₖ=σₖ². In an example implementation, the Metric Update block 232 maps the interleaved LLR's {LLRₖ^{l}} for subcarrier k, to produce its estimate \hat{X}ₖ, and also computes the metric

$${θ}_{k} = - {min}_{l} \{ \vert {LLR}_{k}^{l} \vert \} .$$

In other words, NLS circuitry 216 may determine the subcarrier to be a good if the absolute value of the minimal LLR in the sub-carrier is higher than a threshold. For example, for a 1024-point symbol constellation there may be 10 LLRS per symbol and the minimal LLR may be the smallest of the 10. In an example implementation, to increase diversity, the NLS circuitry 216 may determine good and bad subcarriers per dimension, (e.g. the real part of a particular sub-carrier can be declared “good” while the imaginary part of the particular subcarrier may be determined to be “bad”). For example, for 1024QAM there may be 10 LLRS per symbol with the first 5 of them corresponding to the real component and the second 5 of them corresponding to the imaginary component, and the NLS circuitry 216 may determine the smallest LLR of the first 5 and the smallest LLR of the second 5.

### Updating Good Selection Threshold (Gears)

In an example implementation, the threshold TH is set dynamically (per iteration and codeword) according to some percentile P of the set of metrics {θₖ|k=1 . . . 2N_{cw}_{_{—}}_{syms}}, where the factor of two arises from treating the real and imaginary dimension separately, computed per codeword based on latest FEC decoding, where N_{cw}_{_{—}}_{sym}, is the number of QAM symbols composing the FEC codeword (i.e. the most reliable P % of the set of real and imaginary values of the subcarriers are selected as goods). That is, the sequence of sorted metrics shown in equation (8) may be calculated for each codeword.

$${( {θ}_{s} )}_{s = 1 … 2 {N}_{cw \_ syms}} = sort ( \{ {θ}_{k} \vert k = 1 … 2 {N}_{cw \_ syms} \} ) \qquad ( 8 )$$

The sorting may be performed in increasing order (i.e. starting with θₛ₌₁, which is the most-reliable subcarrier and ending with

$${θ}_{s = 2 {N}_{cw\_syms}} ,$$

which is the least reliable). Per codeword and iteration, the NLS circuitry 216 may set

$$TH = {θ}_{s = P \cdot 2 {N}_{cw \_ syms}} .$$

For each subsequent iteration on the same codeword, and for the next codeword, the NLC circuitry 216 may again sort the metrics and set the threshold based on the P^{th} percentile.

In an example implementation where the decisions as to which subcarriers are good and which are bad is made per complex subcarrier (rather than separately for the real and imaginary dimensions) the metrics {θₖ|k=1 . . . k_{cw}_{_{—}}_{syms}} may be determined per subcarrier and a similar selection process for the threshold TH may be used.

In an example implementation the percentile P used for determining the threshold TH is also changed as the iterations progress. In one example the percentile P may be iteration dependent (i.e. P←Pᵢₜₑᵣ).

### Using “Branches”

For the hard metric case, mistaking a subcarrier dimension (i.e. real dimension or imaginary dimension) that contains erroneously decoded bits as good might result in performance reduction, since the good subcarrier dimensions are not corrected by the NLS circuitry 216 (although the FEC may still correct these bits). This problem may be overcome, in one example, by the NLS circuitry 216 assuming we have total of N_{g} good subcarrier dimensions and running N_{g}+1 times per codeword in the following way: In order to estimate the real and/or imaginary subcarrier dimensions that are bad, the NLS circuitry 216 runs once to minimize the cost function of equation (6) by optimizing ΔX_{kεbads} while the correction for all the good subcarriers dimensions is fixed to zero (i.e., ΔX_{kεgood}=0). Then, for each good subcarrier dimension, (mεgood) the NLS circuitry 216 runs again to minimize the same cost function by optimizing ΔX_{kε{m}∪bads} while setting ΔX_{kεgood-{m}}=0 from which only the m-th subcarrier dimension correction (i.e. ΔXₘ) is used. Since in this case NLS is run to obtain both the good subcarrier dimensions as well as the bad subcarrier dimensions, the outer iterations can effectively handle false goods.

In an example implementation, the NLS circuitry 216 may run fewer times per codeword by dividing the good subcarrier dimensions into N_{B} non-overlapping sets called “branches” B_{b} such that good subcarriers=U_{b=1}^{N}^{_{B}}B_{b}. In an example implementation, the sets may be of approximately the same size. Then the NLS circuitry 216 may run N_{B}+1 times per codeword. In order to estimate the bad subcarrier dimensions, the NLS circuitry 216 runs once, as before, to minimize cost by optimizing ΔX_{kεbads} with correction for all the good subcarrier dimensions fixed to zero (i.e., ΔX_{kεgood}=0). Then, for each branch B_{b} (with b=1, . . . , N_{B}) the NLS circuitry 216 is run again to minimize cost by optimizing ΔX_{kεb}_{_{b}}_{∪bads} while setting ΔX_{kεgood-B}_{_{b}}=0, from which only the branch B_{b} subcarrier dimensions corrections (i.e. ΔX_{kεB}_{_{b}}) are used.

In an example implementation, the same branch scheme may be used, but using only one branch (i.e. using b=1). In this implementation, the NLS circuitry 216 may run only twice per codeword—once to estimate all bad subcarrier dimensions (ΔX_{kεbads}) using the good ones, and a second time to estimate the good subcarrier dimensions (ΔX_{kεgood}) without fixing any correction to zero (i.e. all ΔXₖ are optimized but only output ΔX_{kεgood} is used).

In an example implementation, the percentile P may be increased when the NLS circuitry 216 determines that the number of false good subcarrier dimensions (mistakenly identified as good subcarrier dimensions) for previous iterations is low. This may be based on the latest iteration for branches. In an example implementation, a sequence of successive P values ({Pₗ}_{l=1 . . . L}) is used. The NLS circuitry 216 initially start with 0 good subcarrier dimensions but after the first iteration uses Pₗ·N_{cw}_{_{—}}_{syms} good subcarrier dimensions for l=1. Then, for each additional outer iteration, the NLS circuitry 216 increases l if the latest branch corrections (|ΔX_{kεgood}|) are small enough. In an example implementation, the NLS circuitry 216 may compare the sum (or average) of absolute branch correction Σ_{kεgood}∥ΔXₖ| to a threshold, and increase if the sum (or average) is below the threshold. In an example implementation, the NLS circuitry 216 compares the sum (or average) of some monotonically increasing function f(.) of absolute branch corrections (i.e. Σkε_{good}f(|ΔXₖ|)) to a threshold, and increases l if the sum (or average) is below the threshold. In an example implementation, the NLS circuitry 216 may use f(|ΔXₖ|)=|ΔXₖ|⁴. In an example implementation, the NLS circuitry 216 may divide the good subcarrier dimensions into P groups and for each 1≦q≦P compute the metric ΣΣkε_{good}_{_{—}}ₚf(|ΔXₖ|), and increase the good percentage P_{q} specific to that group. In an example implementation, the two groups may be the real and imaginary parts of the subcarrier symbols (i.e. one group being all the real dimensions and the other group being all the imaginary dimensions). In an example implementation, the NLS circuitry 216 may replace the branch correction ΔXₖ with the difference between latest output of FEC decoder 224 to previous output of NLS circuitry 216 for the good subcarrier dimensions. In an example implementation, the NLS circuitry may replace the branch correction ΔXₖ by the difference between latest output of the FEC decoder 224 and the input to the NLS circuitry 216 for the good subcarrier dimensions. In an example implementation, the NLS circuitry 216 may use a combination of the previous differences between input of NLS circuitry 216, output of NLS circuitry 216, and later output of FEC decoder 224.

In an example implementation, a single instance of NLS circuitry 216 is used but still applies a limited correction to the good subcarrier dimensions by taking advantage of the iterative nature of the NLS circuitry 216, which typically would use inner iterations (not to be confused with outer iterations involving the FEC decoder 224). The inner iterations of the NLS circuitry 216 change only the bad subcarrier dimensions without changing the good ones. On each inner NLS iteration the gradient of the good subcarrier dimensions (typically costing no additional complexity) is computed, but without updating the good subcarrier dimensions. After completing the NLS inner iterations, another gradient descent step is performed using the mean of the good gradient (averaged per-subcarrier dimension over all NLS inner iterations) this time updating the good subcarrier dimensions. In an example implementation, this gradient step is incorporated into the last NLS inner iteration. In this case, the percentile P may be determined defining ΔXₖ as NLS correction to the good subcarrier dimensions (as opposed to previously using the branch correction).

### Solving the Update Metric

In an example implementation, the NLS circuitry 216 finds the ΔX which minimizes the cost function (4) or (6) using an iterative scheme. In an example implementation, the NLS circuitry 216 uses a gradient decent algorithm (GD).

f_{NL} Model.

There are two basic kinds of nonlinearity models: (1) with memory; and (2) without memory. Memoryless power amplifiers are completely characterized by their AM/AM (Amplitude to Amplitude) and AM/PM (Amplitude to Phase) conversions which depend only on the current input signal value.

Learning the nonlinear model, f_{NL}, that accurately approximates/reproduces the nonlinear distortion introduced by the transmitter PA may be accomplished is several ways. For example, the link between a transmitter and a receiver may be established with low-baud-rate packets using low-order modulations (and/or low-amplitude symbols of a higher-order modulation) which are less vulnerable to nonlinear distortion. The receiver may then recover the payload of such packets (using FEC decoding, which may be reliable because of the relatively low amounts of nonlinear distortion in these packets) to recover the transmitted symbols, and then determine the nonlinear distortion through a comparison of the received symbols with the transmitted symbols. Or, where the transmitter knows its nonlinear response, a representation of f_{NL} may be directly transmitted in a payload of such packets. Thereafter, the link may upgrade to higher modulation orders, and/or higher-amplitude symbols, which may be demodulated by using the learned nonlinear model. As another example, the transmitter-receiver pair may use probe signals, known to the receiver a priori, to learn the nonlinear model, where the probe signals may be as specified by an applicable standard. As another example, additional training signals, to be used by the intended receiver for channel estimation and learning of the nonlinear characteristic of the transmitter, may be appended to preambles defined in existing standards.

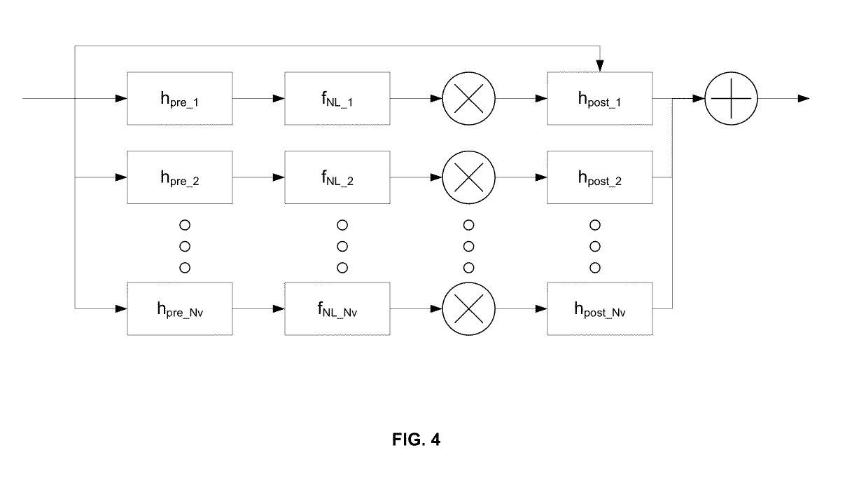

Example circuitry for modeling a nonlinearity is shown in FIG. 4. The circuitry comprises Nv branches, where Nv is the order of the nonlinear model. Each branch comprises circuitry that models the response, h_{prePA}, of pre-f_{NL}_{_{—}}_{V} analog filtering in the PA, the non-linear response, f_{NL}_{_{—}}ᵥ, of the PA, and the response, h_{postPA}, of post-f_{NL}_{_{—}}ᵥ analog filtering in the PA.

In FIG. 4, the PA nonlinearity of the j^{th} branch, f_{NL}_{_{—}}ᵥ (for 1≦v≦Nv) is characterized by AM to AM and AM to PM. In practice, only a very small number of branches may be relevant. hₚᵣₑ_{_{—}}ᵥ may account for causal and anti-causal delays.

The model of FIG. 4 covers all major nonlinearity models (namely: Wiener, Parallel Wiener, Hammerstein, and generalized memory polynomial with cross terms) and provides a good model for PAs for the case of signals whose bandwidth is small compared to the center frequency (even though bandwidth may be large in absolute terms).

Given this general model we can implement the gradient descent with O(N*log N) (where O is a positive number) complexity. Specifically, f_{NL}(x) can be denoted as a complex time function of a complex frequency vector x (note that f_{NL}(x) is not necessarily analytical). It is based on scalar complex functions f_{NL}_{_{—}}_{V}(x) as shown in equation (9).

$${f}_{NL} ( x ) = IDFT ( {\sum }_{v = 0}^{{N}_{V}} {Q}_{v} . \cdot DFT ( {IDFT ( x )}_{n} . \cdot {f}_{NL \_ v} ( {IDFT ( {P}_{v} . \cdot x )}_{n} ) ) ) \qquad ( 9 )$$

The cost function r(x) may then be defined as shown in equation (10).

r(x)=y−H·DFT(f_{NL}(x)) (10)

where Pᵥ, Qᵥ is the frequency response of hₚᵣₑ_{_{—}}ᵥ, and of hₚₒₛₜ_{_{—}}ᵥ respectively.

The “complex pseudo differential” notation of equation (11) can be used for differentiating the scalar complex function of a complex variable, where Δx=re(Δx)+j·im(Δx).

$$Δ {f}_{NL \_ v} ( x ) = ( \frac{1}{2} \cdot \frac{\partial {f}_{NL \_ v}}{\partial Re} - \frac{j}{2} \cdot \frac{\partial {f}_{NL \_ v}}{\partial Im} ) \cdot Δ x + ( \frac{1}{2} \cdot \frac{\partial {f}_{NL \_ v}}{\partial Re} + \frac{j}{2} \cdot \frac{\partial {f}_{NL \_ v}}{\partial Im} ) \cdot Δ {x}^{*} ≡ \frac{\partial {f}_{NL \_ v} ( x )}{\partial x} \cdot Δ x + \frac{\partial {f}_{NL \_ v} ( x )}{\partial {x}^{*}} \cdot Δ {x}^{*} ≡ {df}_{NL 1 \_ v} ( x ) \cdot Δ x + {df}_{NL 2 \_ v} ( x ) \cdot Δ {x}^{*} \qquad ( 11 )$$

The resulting gradient is shown in equation (12).

$${G}_{k} = \frac{\partial \{ {\sum }_{i = 1}^{N} {\vert {r}_{i} ( x ) \vert}^{2} \}}{\partial Re ( {x}_{k} )} + j \frac{\partial \{ {\sum }_{i = 1}^{N} {\vert {r}_{i} ( x ) \vert}^{2} \}}{\partial Im ( {x}_{k} )} = - 2 \cdot \{ {\sum }_{v = 0}^{{N}_{v}} {DFT}_{Σ n} ( {{f}_{NL \_ v} ( {{IDFT}_{Σ k} ( {P}_{v} . \cdot x )}_{n} )}^{*} . \cdot {{R}_{match} ( x )}_{n} ) + {P}_{v , k}^{*} . \cdot {DFT}_{Σ n} ( {{IDFT}_{Σ k} ( x )}_{n}^{*} . \cdot \frac{\partial {f}_{NL \_ v}}{\partial Δ x} {( {{IDFT}_{Σ k} ( {P}_{v} . \cdot x )}_{n} )}^{*} . \cdot {{R}_{match} ( x )}_{n} + {{IDFT}_{Σ k} ( x )}_{n} . \cdot \frac{\partial {f}_{NL \_ v}}{\partial Δ {x}^{*}} ( {{IDFT}_{Σ k} ( {P}_{v} . \cdot x )}_{n} ) . \cdot {{R}_{match} ( x )}_{n}^{*} ) \} \qquad ( 12 )$$

where:
.•—stands for element-by-element multiplication.
Σk—expresses that the size of the IDFT includes all the sub-carriers including sufficient guard band.
Σn—expresses that the size of the DFT includes all the time domain samples.
R_{match}(x)=IDFT_{Σk}(Hₖ*.•Q_{v,k}*.•rₖ(x))

### Pre-PA Modeling

In addition to modeling the PA of the transmitter, the NLS circuitry 216 may also model linear and non-linear response of pre-PA circuitry which operates on x(t) (121 in FIG. 1). In particular, two dominant components may be present: (1) The DNF circuitry 124 (e.g. exhibiting a protective clip response, f_{PC}(x); and (2) the linear response (h_{prepA}) 1 of interpolation filters and analog filtering.

The protective clip of the DNF circuitry 124 may have the form shown in equation (13).

$${f}_{PC} ( x ) = \{ \begin{matrix}x , & \vert x \vert < p clip \\ x / \vert x \vert \cdot p clip , & \vert x \vert \geq p clip\end{matrix} \qquad ( 13 )$$

where pclip is the threshold at which we clip the transmission signal in order to remain in well behaved PA input range (e.g., not exceed a threshold amount of compression).

The combined response, for which the gradient (substantially using the derivation chain rule) is to be calculated may therefore be given by equation (14).

f_{NL}(h_{prePA}*f_{PC}(x)) (14)

where f_{NL} is the model of the response of the PA.

Thus, the sampling rate and bandwidth of the DAC and anti-aliasing filters 126, should be wide enough to accommodate the bandwidth of f_{PC}(x) (which is relatively wide due to clips).

In an example implementation where h_{prePA} is not too sharp (e.g., rolls off less than some threshold amount per decade) within this bandwidth, the transmitter can digitally compensate for h_{prePA} (e.g., by amplifying frequencies that are attenuated by h_{prepA}). In an example implementation where h_{prepA} must be made sharp (e.g. to prevent transmitting aliases), the transmitter can compensate for h_{prePA} to transform it to a linear response—h_{prePAO}—that is known to the receiver. In another example, if the transmitter uses digital predistortion, the combined response f_{NL}(h_{prePA}*f_{PC}(x)) may be transformed to a soft limiter f_{PC}(x) (e.g., by digital predistortion circuitry residing between 124 and 126 in FIG. 1). In another example implementation the receiver may use the training sequence used to estimate f_{NL} and channel, also to estimate h_{prePA0}. In this case the receiver models h_{prePA0} as part of f_{NL} in the minimization of the NLS cost function (e.g. equation (6)).

### Soft Bounds Gradient

For a soft bounds approach, a penalty term (5) is added to the cost, and the NLS circuitry 216 computes the corresponding gradient as shown in (15).

$$2 ( re ( x ) > {X}_{max} ) ( re ( x ) - {X}_{max} ) + 2 ( re ( x ) < - {X}_{max} ) ( re ( x ) + {X}_{max} ) + 2 ( im ( x ) > {X}_{max} ) ( im ( x ) - {X}_{max} ) + 2 ( im ( x ) < - {X}_{max} ) ( im ( x ) + {X}_{max} ) \qquad ( 15 )$$

where
Xₘₐₓ—Is maximum constellation value (e.g. 31 for 1024 QAM)
(a>b)—is 1 if a is greater than b is true and zero otherwise

### Gradient Descent Algorithm

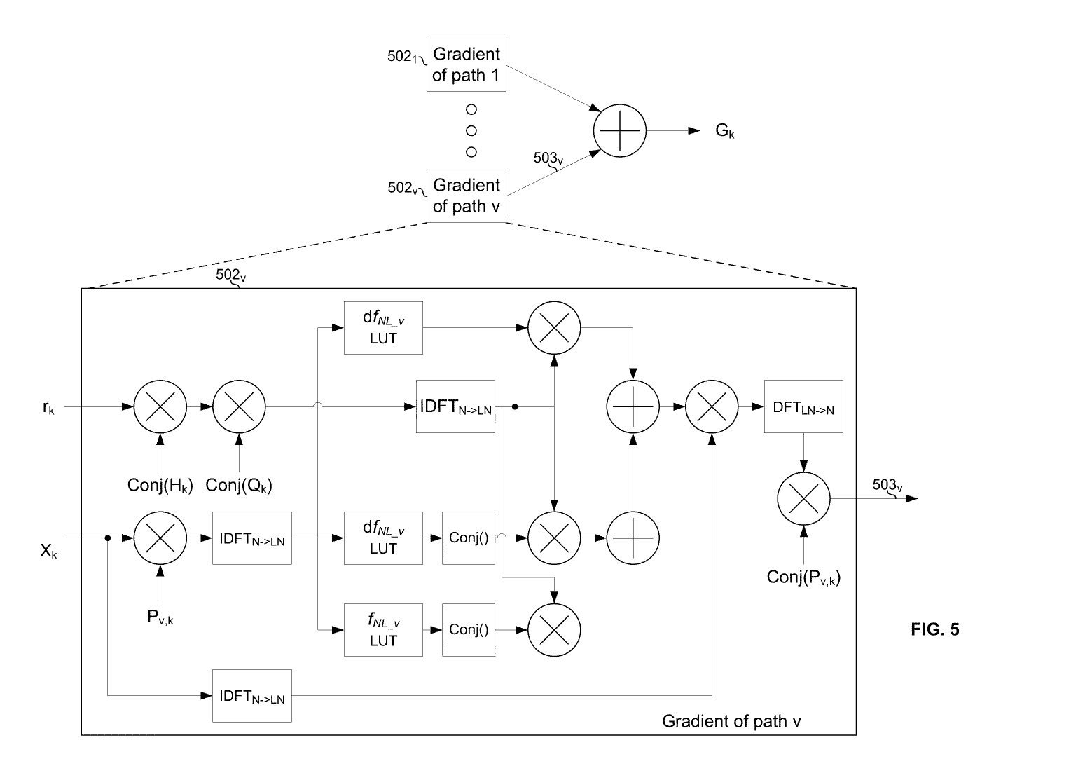

Circuitry for calculating the gradient (except for the optional soft bounds term) is depicted in FIG. 5, where rₖ in FIG. 5 is as shown in equation (16).

rₖ=yₖ−Hₖ·DFT(f_{NL}(x))ₖ (16)

where:
yₖ is received subcarrier k
Hₖ is the channel response matrix for subcarrier k

The Gradient decent algorithm can then be expressed as in equation (17).

$$Δ {X}_{k}^{( i + 1 )} = Δ {X}_{k}^{( i )} + {μ}_{k} \cdot ( {G}_{k} - \frac{2 Δ {X}_{k}^{( i )}}{{σ}_{k}^{2}} ) \qquad ( 17 )$$

where μₖ is a step size, that is 0 for good subcarriers, and a non-zero fixed value for bad subcarriers.

The last term of equation 22 may be used for a ‘soft-metric’ as described above. It is noted that, when Pᵥ is pure delay, the scheme can be simplified extensively. Also, the nonlinear model, though extensive, is just an example. Other, even more elaborate models may be used and a similar derivation may be applied.

In an example implementation, the transceiver and receiver of FIGS. 1 and 2 may use Bit-Interleaved-Coded-Modulation (BICM) (e.g. LDPC). In such an implementation, output 225 of the SISO FEC decoder 224 comprises per-bit Log-Likelihood-Ratios (LLRs). In an example implementation, Euclidean coding (e.g. trellis coded modulation (TCM) or modulation as described in U.S. Pat. No. 8,582,637, which is hereby incorporated herein by reference) may be used to provide likelihood in the Euclidean domain

### Micro FEC Iterations

In an example implementation, the FEC decoder 224 may be an iterative decoder. In an example implementation, the iterative decoder may be run a sufficient number of iterations until it fully converges. However, since the FEC decoder 224 needs to be run for multiple outer iterations, the overall decoder complexity is significant. In an example implementation, in order to reduce the decoding complexity, the iterative FEC decoder is not run until it converges, but rather is stopped substantially prematurely. Despite stopping prematurely, state (accumulated extrinsic information) of the iterative FEC decoder 224 may be maintained and not be reset every outer iteration. With a message passing decoder, this maintenance of state information may be accomplished by continuing the message passing across outer iterations (i.e., messages generated but not processed at outer iteration q, since decoding was stopped, are processed at outer iteration q+1.) In general, this corresponds to adding the NLS as additional check nodes in a Tanner graph which combines both FEC and nonlinearity constraints.

To illustrate, an example implementation in which the FEC decoder 224 is an LDPC decoder will now be described using the following notation:
i, j—the variable node and check node indices correspondingly
L(i)—The LLR of code bit i obtained from demapper 220
L(rⱼᵢ)—Message from check node j to variable node i
L(qᵢⱼ) Message from variable node i to check node j
Cᵢ—Set of check nodes connected to variable node i
Vⱼ—Set of variable nodes connected to check node j

At each outer iteration, the LDPC decoder 224 is fed with output L(i) from demapper 220. Then, the LDPC decoder 224 applies (18) to L(i) and the L(rⱼᵢ) messages stored from the previous outer iteration (denoted L(r_{j′i})), where for the first outer iteration L(r_{j′i})=0) to generate variable node to check node messages. The L(r_{j′i}) messages were generated using (19) to compute the decoded bits output LLRs by the LDPC in the previous outer iteration and, as said, are then processed using (18) to generate messages to check nodes in current (successive) outer iteration. In the current outer iteration, the latest NLS updated L(i), and not the old L(i) that was used for the previous outer iteration, is used in (18).

The LDPC algorithm runs several inner iterations of the form shown in equations

(18) and (19).
Variable node to check node messages:

∀i,j:L(qᵢⱼ)=L(i)+Σ_{j′εC}_{ᵢ}_{-{j}}L(r_{j′i)} (18)
Check node to variable node messages:

∀j,i:L(rⱼᵢ)=2a tan h(π_{i′εv}_{ⱼ}_{-{i}} tan h(½L(q_{i′j}))) (19)

After completing the LDPC iterations, the final check node to variable node messages L(rⱼᵢ) are stored for the next outer iteration, and the LLRs output by FEC decoder 224 are computed using equation (20).

$${L}_{out} ( i ) = L ( i ) + {\sum }_{{j}^{′} ∈ {C}_{i}} L ( {r}_{{j}^{′} i} ) \qquad ( 20 )$$

In the example just discussed, Tanner graph iterative decoding was used in a way that alternates between NLS check node iterations and FEC check node iterations, repeating for some number of outer iterations which may be predetermined and/or dynamically determined. In other implementations, the FEC+NLS Tanner graph based decoder may be iterated in different ways. For example, the NLS and FEC check node may be iterated in parallel, or subsets of NLS and FEC check nodes may be iterated sequentially or in parallel. A similar approach is applicable for other iterative decoders.

### Channel Response and Distortion Estimation

As used here, the “channel response” is the response of the communication medium (e.g., air, copper cable, fiber, etc.) between the output (e.g., antenna for wireless) of the transmitter and the input (e.g., antenna for wireless) of the receiver, and does not include the power amplifier or receiver circuitry. In an example implementation, the channel response (H) may be estimated using preamble(s) or beacon(s) which have low peak-to-average-power ratio (PAPR) such that it suffers only a negligible amount of nonlinear distortion. In an example implementation, the preambles or beacons may intentionally have high PAPR (thus experiencing relatively severe nonlinear distortion), but may be generated/selected to have characteristics (e.g., occupying at least a determined number and/or range of frequencies, occupying at least a determined number of signal levels, and/or providing at least a determined amount of repetition of frequencies and/or signal levels) that allow the same preamble or beacon to be used for both nonlinearity estimation and channel response estimation. In an example implementation, the channel response (H) may be estimated as part of the iterative process performed in the NLS circuit 216, as discussed below.

In an example implementation, in order to estimate both distortion and channel response from the same preamble, the receiver may operate to separate distortion effects and channel effects. To enable this separation, special sequences having the following properties may be transmitted by the transmitter: The sequence is composed of a set of N values that, in the time domain, is denoted as p_{[0]}, p_{[1]} . . . p_{[N-1]}, this set of values is rich enough (e.g., a sufficient number and/or diversity of power levels are present in the sequence) to capture both nonlinearity and channel response (e.g., as few as two levels may suffice for estimating the channel response but more levels may be better for estimating the nonlinearity). The preamble is then composed of a permutation of M such sets of these N values. Therefore circuitry for estimating the distortion and channel (e.g., the NLS circuitry 216) needs to estimate a finite number (N) of distorted transmitted values of the form f_{NL}(p_{[k]}) for k=0 . . . N−1, and the channel response h_{[0]}, h_{[1]} . . . h_{[} [symbol] _{-1]}, where [symbol] is the length of the channel response. This results in N+ [symbol] unknowns with N·M equations, so M>=1+ [symbol] /N is needed for a unique solution. In addition, smoothness constraints may be placed on the estimated nonlinearity in order to reduce estimation noise and/or to reduce the required value of M. By repeating the same values (the M permutations), the number of unknowns remains constant even when preamble length increases, thus enabling a unique solution. In an example implementation, the value of N is selected based on the desired granularity with which it is desired to estimate f_{NL}. This granularity and the set of values selected (p_{[0]}, p_{[1}] . . . p_{[N-1]}) is not necessarily uniformly spaced, as, for example, lower sampling granularity may be used for lower voltage levels (where f_{NL} has low distortion) and higher granularity at higher voltage levels (that are highly distorted). Once the set of preamble values p_{[0]}, p_{[1}] . . . p_{[N-1]} have been determined, a plurality of pseudo random permutations of these values are selected for transmission to support distortion and channel estimation. In an example implementation, the permutations are selected such that the resulting preamble segments are substantially white in frequency.

In an example implementation, the channel response may be estimated using a time domain synchronous (TDS)-OFDM scheme where, instead of using pilots for channel estimation, the guard period is utilized for transmission of a training sequence (i.e. data that is known to the receiver a priori). This scheme is appropriate for the case where the received signal is distorted since the training sequence can be selected to have a desired PAPR (and thus desired amount of nonlinear distortion). By selecting the training sequence, which operates in the time domain, to have a low PAPR (and thus distortion), it can be used for accurate channel estimation. In an example implementation using the TDS-OFDM approach, the same training sequence may be used for nonlinearity estimation on top of channel response estimation. In an example implementation, the TDS-OFDM scheme may be used for nonlinearity estimation (i.e., to determine f_{NL}) but not channel estimation.

In an example implementation using TDS-OFDM, where the data symbol is preceded by a training sequence, the receiver may use a permuted sequence approach similar to that described above. In this case, the same basic set of values p_{[o]}, p_{[1]} . . . p_{[N-1]} where N> [symbol] may be used every TDS-OFDM training sequence, but with each symbol using a different permutation of the same sequence of values. In such an implementation, the receiver may use multiple training sequences (from multiple symbols) to estimate or improve estimation of both the channel response and the nonlinearity. This permuted training sequence is also useful to reduce correlation between the desired signal training sequence, and any interfering sequence of co-channel signals (e.g., interference between different users belonging to different cells in a cellular system).

In an example implementation, a TDS-OFDM scheme may be used for deriving the off-diagonal elements of H for phase noise compensation. In an example implementation, these elements are determined by calculating one or more derivatives (e.g., the 1^{st} and/or 2^{nd} derivative(s)) of H. In an example implementation, the NLS circuitry 216 may calculate the derivative(s) using: (1) the training sequence of a current symbol, (2) training sequence of a next symbol, and (3) tentative decisions of X for the current symbol. Thus, the channel response can be estimated along 3 time instances which enables calculating 1^{st} and 2^{nd} derivative.

In an example implementation the channel may be estimated using je at output of circuit 232, or \hat{X}+ΔX at output of NLS circuitry 216. This may be represented as shown in equation (21).

$$\hat{H} = \frac{Y}{DFT ( {f}_{NL} ( IDFT ( \hat{X} ) ) )} * W \qquad ( 21 )$$

where
* denotes convolution
W filter is a ‘smoothing’ filter based on channel power delay profile. W may also account for the fact that channel response is sparse in time if the path/reflection delays from previous packets received from same user are already known (since path delays change slowly in time).

Thus, even if \hat{X} is with errors, the ‘smoothing’ of filter W enables accurate channel estimation. Thus, per each iteration when errors decrease, the NLS circuitry 216 can derive an improved channel estimation. For the 1^{st} iteration on a particular OFDM symbol, in slow-varying channels, the NLS circuitry 216 may use the channel estimation of a previous symbol (the immediately previous symbol or an even earlier symbol). For the 1^{st} iteration on a particular OFDM symbol, in fast-varying channels, the NLS circuitry 216 may use a TDS-OFDM or similar scheme.

In an example implementation (e.g. where transmit power control continuously changes the input backoff), the transmitter may inform the receiver of its current input backoff. In an example implementation, this can be transmitted using the packet header and, assuming the packet header uses lower constellation points, the header can be demodulated despite the compression. This allows the receiver to use the f_{NL} estimation computed for one or more previous packets after compensating it for input backoff changes. The previous f_{NL} estimation may be used either instead of the f_{NL} estimation generated from a training sequence or in addition to the f_{NL} estimation generated from a training sequence (to reduce estimation noise). When the input backoff changes, the transmitter may also vary the protective clip saturation level to correspond to an approximately fixed level below the analog saturation ppoint (Psat). That is, in an example implementation, the protective clip saturation level is a function of the input backoff. The receiver can then use the input backoff transmitted as part of the header to set its expected protective clip level to be exactly equal to that of the transmitter.

### Efficient Use of Cyclic Prefix

In a conventional OFDM system, a cyclic prefix may be used to reduce ISI and to simplify equalization to per bin multiplication. This is the result of the cyclic prefix turning linear convolution into cyclical convolution. A receiver such as shown in FIG. 3, however, does equalization implicitly vs. the cost function minimization, and handles distortion between demodulated bins by use of iterative convergence. Therefore, avoiding ISI and simplified equalization through use of a cyclic prefix are not needed. Thus, the receiver of FIG. 3 can work without a cyclic prefix, or alternately, use the energy of the cyclic prefix as follows: The receiver of FIG. 3 can model the linear convolution including the previous symbol ISI using the following cost function:

$${\sum }_{n = - {N}_{cp}}^{{N}_{FFT} - 1} \frac{1}{{σ}_{v}^{2}} {\vert r ( n ) - {h}_{isi} * IDFT ( {\hat{X}}_{t - 1} ) - h * {f}_{NL} ( IDFT ( {\hat{X}}_{t} ) + IDFT ( Δ {X}_{t} ) ) \vert}^{2} + {\sum }_{k = 0}^{{N}_{FFT} - 1} \frac{{\vert Δ {X}_{k} \vert}^{2}}{{σ}_{k}^{2}} \qquad ( 22 )$$

In this case, summation occurs not only over N_{FFT} samples, but also over the cyclic prefix. Thus, if the receiver uses the cyclic prefix its energy is not wasted. The ISI from the previous symbol is mitigated by convolving the symbol estimation for the previous symbol with the isi response (hᵢₛᵢ), where the previous symbol estimate (\hat{X}ₜ₋₁) is based on processing of the previous symbol by the NLS circuitry 216 (which has more advanced outer iteration, see discussion of pipelined structure below). The receiver of FIG. 3 may also use non-cyclic convolution by channel response (h).

### Pipelined Structure of Hardware

In an example implementation, the receiver of FIG. 3 may use a pipelined hardware architecture in which several receive paths operate concurrently on several code words. In such an implementation, a first path may handle outer iteration J (a positive integer) on code word M while, a second path (if present) may operate on outer iteration J−1 on code word M+1, a third path (if present) may concurrently operate on outer iteration J−2 on code word M+2, and so on for as many paths as is desired. In an example implementation comprising at least two such paths, during the 1^{st} iteration (in slow varying channels), processing of OFDM symbols belonging to code word M+1 may use channel estimation based on symbols belonging to the second iteration of code word M. In an example implementation, the derivative of the channel for symbols belonging to code word M, iteration J can be derived from the channel estimation from symbols belonging to code word M−1, iteration J+1 and the channel estimation from symbols belonging to code word M+1, iteration J−1.

For the case of misalignment between code words and symbols, operating the NLS circuitry 216 code word by code word (i.e. not pipelined) may induce some performance loss because, when applying NLS circuitry 216 for code word M that shares a symbol with code word M+1, the NLS circuitry 216 has no estimation (\hat{X}ₖ) from the FEC decoder 224 for subcarriers in the shared symbol belonging to code word M+1. In an example implementation, the pipelined implementation is used to obtain \hat{X}ₖ for the shared symbol. That is, the first path may handle outer iteration J (a positive integer) on code word M while a second path (if present) may operate on outer iteration J−1 on code word M+1. In this case, for first path outer iteration J running on last/shared symbol (of code word M), the NLS circuitry 216 may use the shared symbol subcarriers estimations \hat{X}ₖ obtained by the FEC decoder 224 for second path outer iteration J−1 on code word M+1.

The pipelined structure can also be used in OFDMA scenario where different packets from different users (on adjacent frequencies) are not aligned. In OFDMA, non-linear distortion leaks from one user to the adjacent users in frequency. The NLS receiver can start processing a user packet as soon as a code word becomes available without using “goods”, related to code words that haven't been processed yet. However whenever an adjacent (in frequency or time) code word has been processed the receiver of FIG. 3 may use the most recent soft information obtained for it by the decoder (LLR's and estimation \hat{X}ₖ).

### Using Off Diagonal Elements in H to Handle Phase Noise and Fast Varying Channels.

The channel is assumed to be composed of several reflections, each reflection delays the transmitted signal and multiplies it by a complex factor, the formulation for such a channel is depicted in equation (23).

$$h ( t ) = {\sum }_{i} {h}_{i} ( t ) \cdot δ ( t - {τ}_{i} ) \qquad ( 23 )$$

where, in slow varying channels (e.g., where estimation using a one-symbol delay is provides sufficient SNR), and when phase noise is weak enough (e.g., below a determined threshold), it is assumed that hᵢ(t) is constant within the duration of an OFDM symbol. However, in the presence of phase noise and/or when channel varies fast this assumption no longer holds. In this case, a Taylor expansion may be used around the middle of the OFDM symbol, which results in the formulation of equation (24).

$${h}_{i} ( t ) = {h}_{i} ( {T}_{SYM} / 2 ) + {\sum }_{p = 1}^{P} \frac{{h}_{i}^{( p )}}{p !} \cdot {( t - \frac{{T}_{SYM}}{2} )}^{p} \qquad ( 24 )$$

Where hᵢ^{(p)} is the p^{th} derivative of hᵢ(t) at the middle of the OFDM symbol (i.e. at time instant T_{sym}/2).

Using (24), and under the assumption that the cyclic prefix is longer than the maximal path delay, τ, it can be shown that:

$${{X}^{⋒}}_{k} = {H}_{k} \cdot {X}_{k} + {\sum }_{p = 1}^{P} ( {X}_{k} \cdot {H}_{k}^{( p )} ) * {L}^{( p )} \qquad ( 25 )$$

where L^{(p)} is the Fourier transform of

$$\frac{{( t - \frac{{T}_{SYM}}{2} )}^{p}}{p !}$$

(i.e.

$${L}_{k}^{( p )} = \frac{1}{p !} {\int }_{0}^{{T}_{SYM}} {( t - \frac{{T}_{SYM}}{2} )}^{p} \cdot {e}^{( j \frac{2 \cdot π \cdot k \cdot t}{{T}_{SYM}} )} \cdot d t )$$

* denotes convolution

$${H}_{k} = {\sum }_{i} {h}_{i } ( {T}_{SYM} / 2 ) \cdot {e}^{j \cdot 2 \cdot π \cdot k \cdot {τ}_{i}}$$

$${H}_{k}^{( p )} = {\sum }_{i} {h}_{i }^{( p )} \cdot {e}^{j \cdot 2 \cdot π \cdot k \cdot {τ}_{i}}$$

Equation (25) can be represented in matrix form as shown in equation (26).

\hat{X}=H·X (26)

where:

$$\underline{\underline{H}} = diag ( [ \begin{matrix}{H}_{0} & … & {H}_{k} & … & {H}_{N - 1}\end{matrix} ] ) + {\sum }_{p = 1}^{P} {\underline{\underline{L}}}^{( p )} \cdot diag ( [ \begin{matrix}{H}_{0}^{( p )} & … & {H}_{k}^{( p )} & … & {H}_{N - 1}^{( p )}\end{matrix} ] )$$

L^{(p)} is the convolution matrix of L^{(p)}.

Since L^{(p)} decays, which accounts for the fact that the variations cause Inter Carrier Interference (ICI) that diminishes as carriers are further apart, considering only a few off-diagonal elements is sufficient in an example implementation.

Approximation of Hₖ^{(p)} requires knowledge of Hₖ at p+1 time instances. In an example implementation using TDS-OFDM, Hₖ⁽¹⁾ is estimated using the estimation of Hₖ in the pseudorandom binary sequence that precedes the symbol and the pseudorandom binary sequence that follows it. This implementation provides accurate estimations of Hₖ at symmetrical, relatively short (approximately half a OFDM symbol period) distances from the middle of the OFDM symbol. For other implementations where the distances are larger (e.g., to more than the duration of one OFDM symbol), the accuracy of the approximation of the derivative becomes less accurate. In an example implementation in which pilots are transmitted as well, then the receiver may be enabled to generate an accurate estimate Hₖ⁽²⁾.

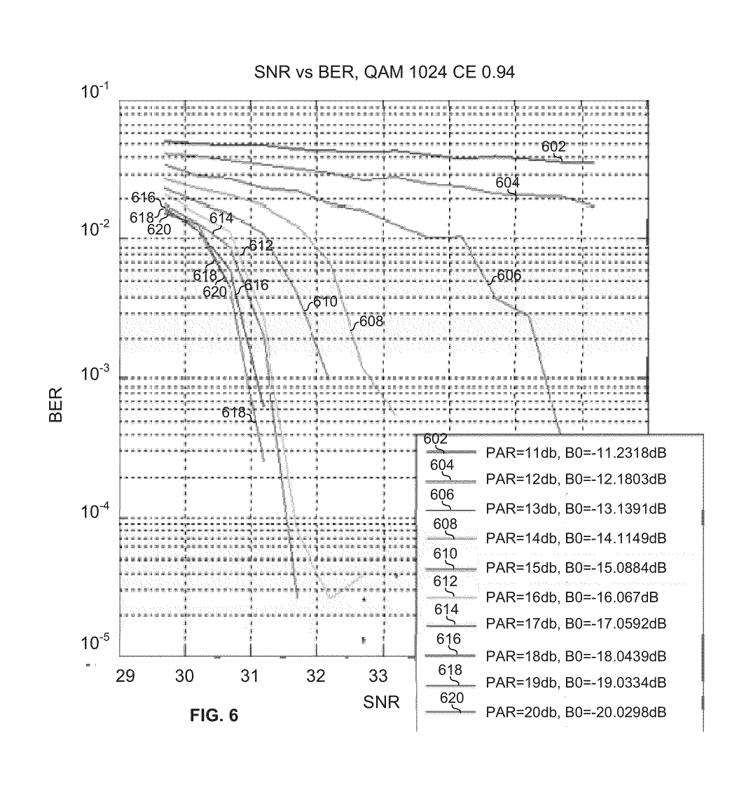

The graph of FIG. 6 corresponds to a conventional QAM OFDM system which uses LDPC code, the minimal SNR for this system is 31.2 dB. The system is optimal when Back-Off (BO) at PA output is 20 dB. As can be seen, when BO decreases there is severe penalty in SNR. When BO is smaller than 12 dB the system cannot work at any signal-to-noise ratio (SNR).

In contrast to the system represented by the graph of FIG. 6, the following list shows the BER of a system in accordance with aspects of this disclosure with SNR which is 0.5 dB lower than the minimal SNR of the conventional receiver of FIG. 6. The system uses the cost function of equation (4). As can be seen, after 10 iterations the system has a BER of zero. I.e. the system gain is about 20 dB.

SNR=30.69, BER=3.4108e-001, PAR=0 dB, BO=−2.6 dB, Iter 1

SNR=30.69, BER=1.9686e-001, PAR=0 dB, BO=−2.6 dB, Iter 2

SNR=30.69, BER=1.4653e-001, PAR=0 dB, BO=−2.6 dB, Iter 3

SNR=30.69, BER=1.1454e-001, PAR=0 dB, BO=−2.6 dB, Iter 4

SNR=30.69, BER=7.8093e-002, PAR=0 dB, BO=−2.6 dB, Iter 5

SNR=30.69, BER=4.6717e-002, PAR=0 dB, BO=−2.6 dB, Iter 6

SNR=30.69, BER=2.1066e-002, PAR=0 dB, BO=−2.6 dB, Iter 7

SNR=30.69, BER=5.7000e-003, PAR=0 dB, BO=−2.6 dB, Iter 8

SNR=30.69, BER=8.0116e-004, PAR=0 dB, BO=−2.6 dB, Iter 9

SNR=30.69, BER=0.0000e+000, PAR=0 dB, BO=−2.6 dB, Iter 10

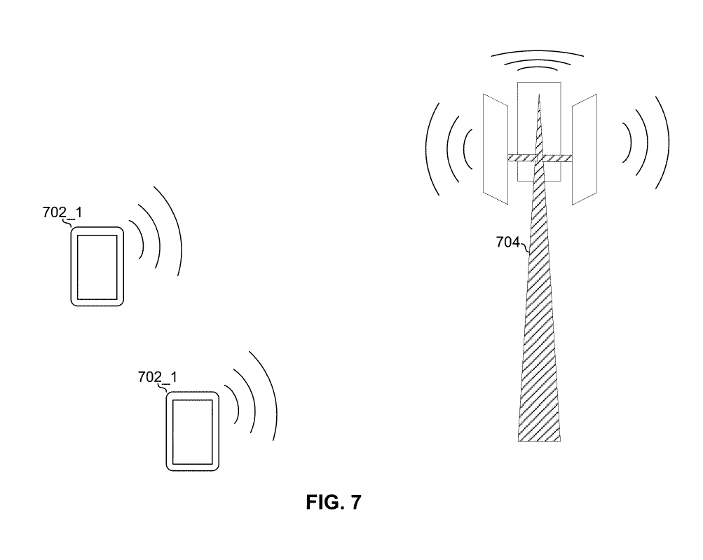

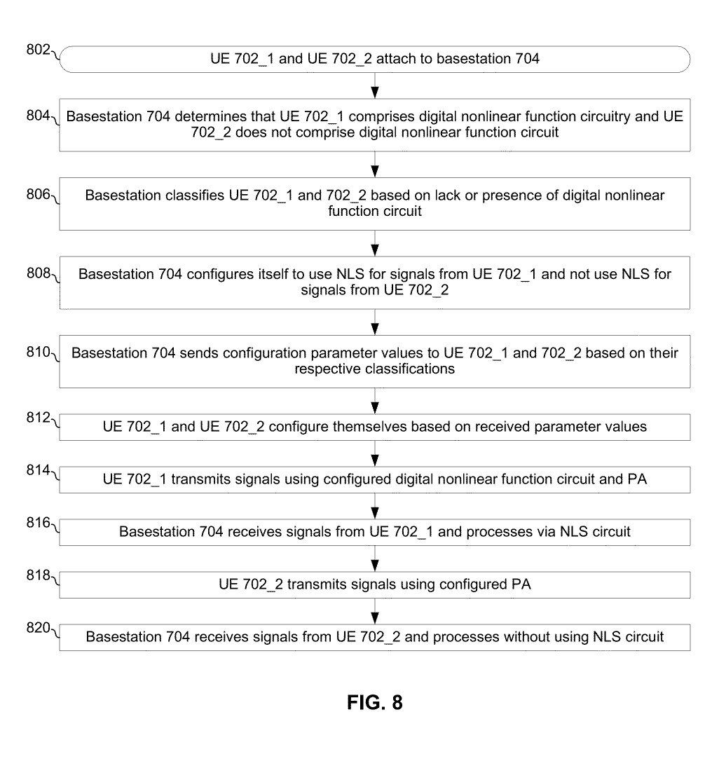

FIG. 7 depicts an example wireless communication system. The system comprises two pieces of user equipment (e.g., smartphones) 702_1 and 702_2 and a basestation 704 (e.g., an LTE EnodeB). Each of the UE 702_1, the UE 702_2, and the basestation 704 may comprise an instance of the transmitter of FIG. 1 and an instance of the receiver of FIG. 3. An example scenario of operation of the communication system of FIG. 7 is described with reference to the flowchart of FIG. 8.

In block 802, UE 702_1 and UE 702_2 attach to basestation 704. The handshaking/signaling that occurs as part of the attachment may include communication of information that enables the basestation to determine whether each of the UEs comprises the digital nonlinear function circuit (see FIG. 1) and to learn the nonlinearity of signals received from the two UEs.

In block 804, basestation 704 determines that UE 702_1 comprises digital nonlinear function circuit 122 and UE 702_2 does not comprise digital nonlinear function circuit 122.

In block 806, the basestation classifies UE 702_1 and 702_2 based on lack or presence of digital nonlinear function circuit. For example, even assuming UE 702_1 and 702_2 have RF front-ends which exhibit substantially similar performance (e.g., power amplifiers having substantially similar transfer functions and mixers/local oscillators which introduce substantially similar amounts of phase noise) UE 702_1 may be classified into a first class while UE 702_2 is classified into a second class, where the first class permits, for example, higher transmit power than the second class, higher modulation order than the second class, higher code rate than the second class, and/or other characteristics corresponding to higher performance (e.g., as measured by throughput).

In block 808, the basestation 704 configures itself to use its NLS circuit (see FIG. 2) for processing signals from UE 702_1 and not use its NLS circuit for processing signals from UE 702_2.

In block 810 the basestation 704 sends UE 702_1 and 702_2 their respective classifications (and/or parameter values based on their classifications).

In block 812, the UEs 702_1 and 702_2 configure themselves based on their respective classifications. For example, each may configure its power amplifier backoff, its order of modulation, and its FEC code rate based on its classification. The UE 702_1 may additionally configure its digital nonlinear function based on the classification (e.g., either directly based on the classification and/or indirectly based on the configuration of the power amplifier, etc. according to the classification).

In block 814, the configured UE 702_1 transmits a signal.

In block 816, the basestation 704 receives the signal transmitted by UE 702_1 and processes the signal using its NLS circuit.

In block 818, the configured UE 702_2 transmits a signal.

In block 820, the Basestation 704 receives the signal from UE 702_2 and processes without using NLS circuit.

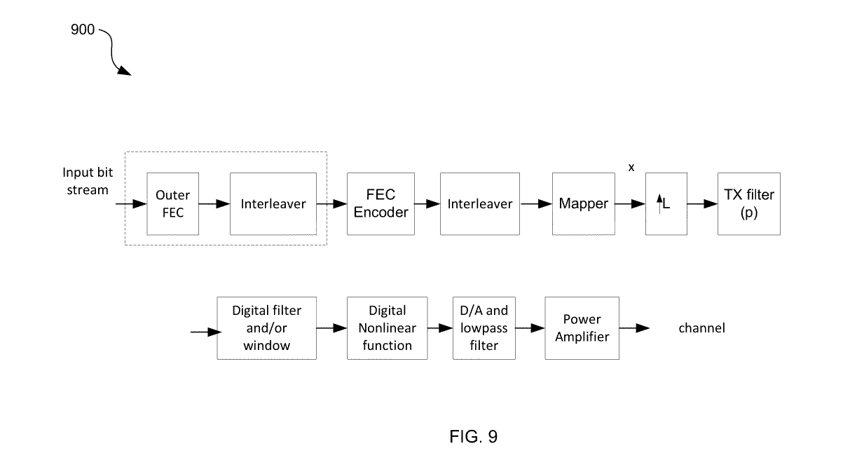

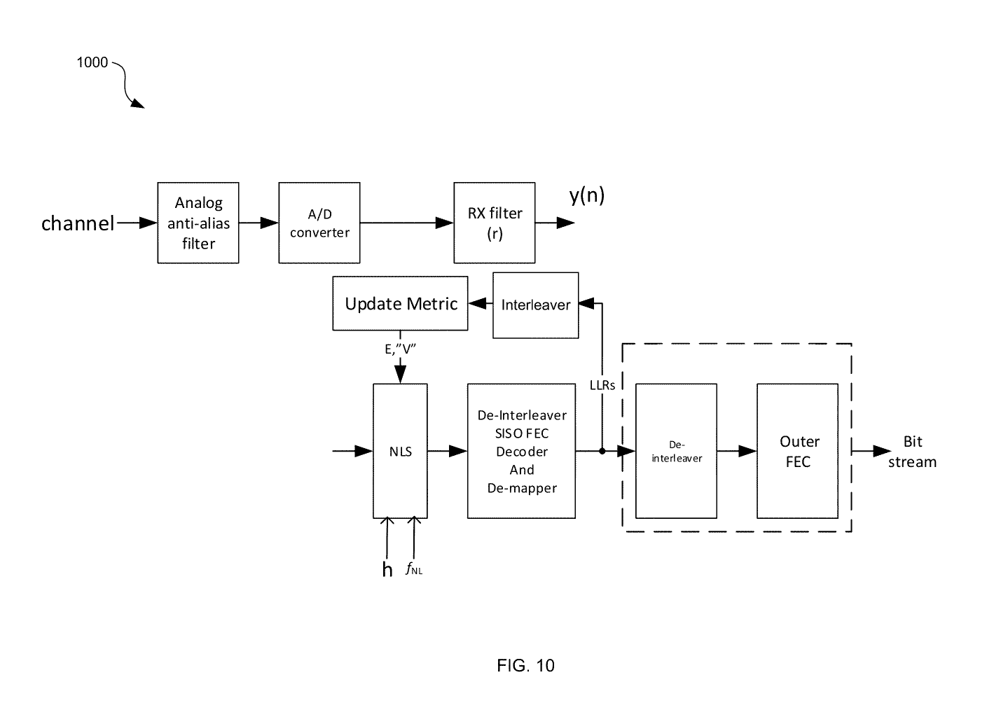

Aspects of the above multi-carrier communication system can also be applied to a single-carrier communication system such as shown in FIGS. 9 and 10, to which attention is now directed.

### Digital Nonlinear Function

As the system of FIGS. 9 and 10 is expected to operate in scenarios where the Power Amplifier (PA) is deeply compressed, without the digital nonlinear function circuit (FIG. 9) (which introduces digital predistortion such as, for example, protective clipping) the AM to AM characteristic of the PA may be not one-to-one, as depicted FIG. 2. As in the OFDM case, the digital nonlinear function circuit may predominate the overall nonlinear characteristic of the single-carrier transmitter 900 in order to reconstruct the data with substantially known nonlinear characteristic (as the nonlinear of the PA may vary in time).

### Update Metric

In various example implementations, the single-carrier receiver 1000 uses iterations, where at each iteration the SISO (Soft-In-Soft-Out) FEC (“inner FEC”) output together with the ADC output is used to improve the received symbols by partially compensating for the nonlinear characteristic of the transmitter.

### Example Single-Carrier NLS Implementation

Using the following cost function:

$$\frac{1}{{σ}_{v}^{2}} \cdot {\vert \vert h * r * {f}_{NL} ( p * \tilde{x} ) - y * r \vert \vert}^{2} + {\sum }_{k = 0}^{CW - 1} \frac{{\vert Δ {X}_{k} \vert}^{2}}{{σ}_{k}^{2}} \qquad ( 27 )$$

Where:
∥•∥—denotes the Frobenius norm of a vector;
\acute{x}—is the up-sampled \hat{x}, i.e. \hat{x} padded with zero's (\hat{x} (1),0,0,0, \hat{x} (2),0,0,0, . . . );
\hat{x}—is the estimation of the transmitted symbols vector;
y—is the received signal after the RX filter;
r is the RX filter;
CW—is the number of symbols in a code-word;
f_{NL}(x)—is the overall non-linear response of the transmitter (of the analog circuitry and the digital nonlinear function) as depicted above (AM to AM and AM to PM), which can be implemented either as a function or Look Up Table (LUT);
p—is the TX filter;
h—is the channel response; and
ΔXₖ—is an estimation of the error at symbol k, i.e element k of the vector X_{Transmit}−\hat{X};
   Hard Metric Vs. Soft Metric

The 2nd term in equation (27) above indicates the reliability of Xₖ. When σₖ² is close to 0, the cost would not allow finding ΔXₖ which are not very small. In other words, the bigger the estimated value of ΔXₖ, the less certain the system must be that the estimate is correct before using the estimate.

In another example implementation, the second term may be dropped from (27). Rather, the NLS may determine which of the elements in x are reliable, (denotes as “good symbols”) and which elements in x are unreliable (“bad symbols”). During the 1st iteration code-word in the NLS, it may be assumed that all symbols are bad. The NLS may then search for CW ΔXₖ elements. Then, in later iterations, the NLS gets information from the SISO FEC decoder which enables it to lower the number of ΔXₖ elements in the search, i.e. the good symbols are constants, and the problem boils down to finding the bad symbols that minimize the cost. Thus we search for N_{bad} (where N_{bad}<CW) ΔXₖ elements corresponding to the N_{bad} bad symbols. In such an implementation, the hard metric cost function may be:

$$\frac{1}{{σ}_{v}^{2}} \cdot {\vert \vert h * r * {f}_{NL} ( p * \tilde{\tilde{x}} ) - y * r \vert \vert}^{2} \qquad ( 28 )$$

### Where:

{tilde over (\tilde{x} is an up-sampled {circumflex over (\hat{x}ₖ, and

$${\hat{\hat{x}}}_{k} = \{ \begin{matrix}{\hat{x}}_{k} & when {θ}_{k} ∈ Good \\ {\hat{x}}_{k} + Δ {X}_{k} & otherwise\end{matrix}$$

θₖ—is a metric that is used to determine if symbol is a good symbol or a bad symbol. In an example implementation, the NLS may determine θₖ based on a comparison of σₖ², to one or more determined thresholds (TH) (e.g. if σₖ²<TH than symbol is good). In another example implementation, the NLS may determine whether the absolute value of the minimal LLR in the symbol is higher than a threshold. If so, the NLS may determine the symbol to be a good subcarrier. For example, for a 1024 point symbol constellation (e.g., 1024QAM) there may be 10 LLRS per symbol and the minimal LLR may be the smallest of the 10. In an example implementation, to increase diversity, the NLS may determine good and bad subcarriers per dimension, e.g. the real part of a particular sub-carrier can be declared “good” while the imaginary part of the particular subcarrier may be determined to be “bad”. For example, For example, for a 1024 point symbol constellation (e.g., 1024QAM) there may be 10 LLRS per symbol with the first 5 of them corresponding to the real component and the second 5 of them corresponding to the imaginary component, and the NLS may determine the smallest LLR of the first 5 and the smallest LLR of the second 5.

### Using FTN

In a Faster Than Nyquist (FTN) scheme, the baud rate (i.e. the rates in which the symbols are transmitted) is larger than the bandwidth of the transmission. The transmit filter (p) has to be designed to filter out energy outside the allowed bandwidth which creates Inter Symbol Interference (ISI). Using FTN in conjunction with aspects of this disclosure proves useful for at least two reasons:
1. Capacity of FTN is higher than non FTN, as non FTN scheme is less optimal in using the energy outside the baud (roll-off section). This is inherent to FTN and is not related directly to the invention.
2. Current invention actually benefits from the ISI that is generated by the transmit filter.

### LLR Scaling for Decoder

A conventional de-mapper would consider the noise variance when calculating the LLR's. In the presence of non-linearity it is required to consider not only the additive noise but also distortion noise.

In accordance with an example implementation of this disclosure, single-carrier receiver (e.g., the receiver 1000) comprises a forward error correction (FEC) decoder and a nonlinearity compensation circuit. The nonlinearity compensation circuit is operable to generate estimates of constellation points transmitted on a received signal based on soft decisions from the FEC decoder and based on a model of nonlinear distortion introduced by a transmitter from which the received signal was received. The generation of the estimates may be based on a measure of distance between a function of the received signal and a synthesized version of the received signal. The generation of the estimates may comprise iterative processing of symbols of the received signal, and the iterative processing may comprise a plurality of outer iterations and a plurality of inner iterations. The estimates may be an output of the nonlinearity compensation circuit during a first particular outer iteration, and the soft decisions may be an output of the FEC decoder during a second particular outer iteration preceding the first particular outer iteration. The estimates may be an output of the nonlinearity compensation circuit during a first particular outer iteration, and for each of the inner iterations for the particular outer iteration, the FEC decoder may generate variable-node-to-check-node messages based on the estimates. For a first one of the inner iterations for a first particular one of the outer iterations, the FEC decoder may generate variable-node-to-check-node messages based on check-node-to-variable-node messages generated during a last one of the inner iterations for a second particular one of the outer iterations. For the second particular one of the outer iterations, the inner iterations may be halted before the FEC decoder converges. For a particular one of the outer iterations, the soft decisions from a previous one of the outer iterations may be categorized and adjusted based on a category (e.g., “good” or “bad”) into which they are placed, the adjustment resulting in adjusted soft decisions, and the estimates for the particular one of the iterations may be generated based on the adjusted soft decisions. For a particular one of the outer iterations, an expectation may be calculated using the soft decisions from a previous one of the outer iterations, and the generation of the estimates may be based on the expectation. The nonlinearity compensation circuitry may be operable to, during each successive outer iteration, refine one or more of the estimates generated during a previous outer iteration based on the soft decisions output by the FEC decoder during the previous outer iteration. The refinement may be limited by one or more constraints (e.g., constrained to a determined value or range of values). The constraints may be determined based on the soft decisions (e.g., based on whether reliability is above or below a threshold). The constraints may be updated for each successive one of the outer iterations. The generation of the estimates of the transmitted constellation points may be based on a metric of distance between symbol estimation and the expectation, and the metric may be affected from soft reliability measures. The nonlinearity compensation circuit may be operable to generate the model based on a training sequence transmitted by the transmitter. The training sequence may have a peak-to-average power ratio that causes an output of the power amplifier of the transmitter to compress and introduce nonlinear distortion. The training sequence comprises multiple permutations of a determined sequence of symbols. For processing a particular received symbol, the nonlinearity compensation circuit may be operable to determine the model of nonlinear distortion based on a first training sequence that preceded the particular received symbol and a second training sequence that followed the particular received symbol. The nonlinearity compensation circuitry may be operable to use the first training sequence and the second training sequence to estimate phase noise present in the received signal. Each of the soft decisions may correspond to only one or both of: a real dimension of the received signal and an imaginary dimension of the received signal. The estimate of nonlinear distortion introduced by the transmitter accounts for a digital nonlinear function implemented in the transmitter. The digital nonlinear function may be a protective clip.

As utilized herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As utilized herein, the terms “e.g.,” and “for example” set off lists of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled, or not enabled, by some user-configurable setting.

The present method and/or system may be realized in hardware, software, or a combination of hardware and software. The present methods and/or systems may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip. Some implementations may comprise a non-transitory machine-readable (e.g., computer readable) medium (e.g., FLASH drive, optical disk, magnetic storage disk, or the like) having stored thereon one or more lines of code executable by a machine, thereby causing the machine to perform processes as described herein.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. Therefore, it is intended that the present method and/or system not be limited to the particular implementations disclosed, but that the present method and/or system will include all implementations falling within the scope of the appended claims.

What is claimed is:

1. A System comprising:
an single carrier receiver comprising a forward error correction (FEC) decoder and a nonlinearity compensation circuit, wherein:
said nonlinearity compensation circuit is operable to generate estimates of constellation points transmitted on a received signal; and
said generation of said estimates is based on:
soft decisions from said FEC decoder; and
a model of nonlinear distortion introduced by a transmitter from which said received signal was received.

2. The system of claim 1, wherein said generation of said estimates is based on a measure of distance that is either: between a function of said received signal and a synthesized version of said received signal, or between said estimates and decoder soft values.

3. The system of claim 1, wherein:
said generation of said estimates comprises iterative processing of symbols of said received signal; and
said iterative processing comprises a plurality of outer iterations and a plurality of inner iterations.

4. The system of claim 3, wherein:
said estimates are an output of said nonlinearity compensation circuit during a first particular outer iteration; and
said soft decisions are an output of said FEC decoder during a second particular outer iteration preceding said first particular outer iteration.

5. The system of claim 3, wherein:
said estimates are an output of said nonlinearity compensation circuit during a first particular outer iteration; and
for each of said inner iterations for said particular outer iteration, said FEC decoder generates variable-node-to-check-node messages based on said estimates.

6. The system of claim 3, wherein:
for a first one of said inner iterations for a first particular one of said outer iterations, said FEC decoder generates variable-node-to-check-node messages based on check-node-to-variable-node messages generated during a last one of said inner iterations for a second particular one of said outer iterations.

7. The system of claim 6, wherein, for said second particular one of said outer iterations, said inner iterations are halted before said FEC decoder converges.

8. The system of claim 3, wherein:
for a particular one of said outer iterations, said soft decisions from a previous one of said outer iterations are categorized and adjusted based on a category into which they are placed, said adjustment resulting in adjusted soft decisions; and
said estimates for said particular one of said iterations are generated based on said adjusted soft decisions.

9. The system of claim 3, wherein:
for a particular one of said outer iterations, an expectation is calculated using said soft decisions from a previous one of said outer iterations; and
said generation of said estimates is based on said expectation.

10. The system of claim 3, wherein said nonlinearity compensation circuitry is operable to:
during each successive outer iteration, refine one or more of said estimates generated during a previous outer iteration based on said soft decisions output by said FEC decoder during said previous outer iteration.

11. The system of claim 10, wherein:
said refinement is limited by one or more constraints; and
said constraints are determined based on said soft decisions.

12. The system of claim 11, wherein said constraints are updated for each successive one of said outer iterations.

13. The system of claim 10, wherein said generation of said estimates of said transmitted constellation points is based on a metric of distance between symbol estimation and said expectation, and said metric is affected from soft reliability measures.

14. The system of claim 1, wherein:
said nonlinearity compensation circuit is operable to generate said model based on a training sequence transmitted by said transmitter; and
said training sequence has a peak to average power ratio that causes an output of said power amplifier of said transmitter to compress and introduce nonlinear distortion.

15. The system of claim 14, wherein said training sequence comprises multiple permutations of a determined sequence of symbols.

16. The system of claim 1, wherein, for processing a particular received symbol, said nonlinearity compensation circuit is operable to determine said model of nonlinear distortion based on a first training sequence that preceded said particular received symbol and a second training sequence that followed said particular received symbol.

17. The system of claim 16, wherein said nonlinearity compensation circuitry is operable to use said first training sequence and said second training sequence to estimate phase noise present in said received signal.

18. The system of claim 1, wherein each of said soft decisions corresponds to only one of: a real dimension of said received signal and an imaginary dimension of said received signal.

19. The system of claim 1, wherein said estimate of nonlinear distortion introduced by said transmitter accounts for a digital nonlinear function implemented in said transmitter.

20. The system of claim 19, wherein said digital nonlinear function is a protective clip.
